(19) United States
(12) Patent Application Publication
(10) Pub. No.: US 2026/0218657 A1
(43) Pub. Date: Jul. 30, 2026

(54) CONTROLLING THE DYNAMIC BEHAVIOR OF AN AERONAUTICAL PROPULSION SYSTEM

(71) Applicant: SAFRAN AIRCRAFT ENGINES, PARIS (FR)

(72) Inventor: Didier René André ESCURE, MOISSY-CRAMAYEL (FR)

(73) Assignee: SAFRAN AIRCRAFT ENGINES, PARIS (FR)

(21) Appl. No.: 19/141,529

(22) PCT Filed: Dec. 22, 2023
(86) PCT No.: PCT/FR2023/052098

§ 371 Date: Jun. 20, 2025

(30) Foreign Application Priority Data
Dec. 22, 2022 (FR) FR2214348

(51) Int. Cl. F02C 7/06; F02K 3/02

(52) U.S. Cl. CPC F02C 7/06; F02K 3/02; F05D 2200/11; F05D 2200/12; F05D 2200/13; F05D 2200/14; F05D 2200/221; F05D 2220/323; F05D 2240/50

(57) ABSTRACT

An aeronautical propulsion system includes a fan rotor to be driven by a fan shaft, a drive turbine that drives the fan rotor through a drive shaft about an axis of rotation, a reduction structure that couples the drive shaft and the fan shaft to drive the fan shaft at a rotation speed less than a rotation speed of the drive shaft, and bearings that center the drive shaft with respect to the axis of rotation and that include one front bearing extending upstream of a combustion chamber of the propulsion system and two rear bearings extending downstream of the combustion chamber. The position of the bearings in the propulsion system obeys a formula based on various parameters related to the bearings, the drive turbine, and the drive shaft.

### TECHNICAL FIELD

This application generally relates to the field of propulsion systems, and more specifically aeronautical propulsion systems comprising a ducted or unducted fan and having a high, or very high, bypass ratio.

### BACKGROUND

A propulsion system generally includes, from upstream to downstream in the direction of flow of the gas, a fan section, a compressor section that may comprise a low-pressure compressor and a high-pressure compressor, a combustion chamber and a turbine section which may particularly comprise a high-pressure turbine and a low-pressure turbine. The high-pressure compressor is rotationally driven by the high-pressure turbine by way of a high-pressure shaft. The fan and where applicable the low-pressure compressor are rotationally driven by the low-pressure turbine by way of a low-pressure shaft.

Technology research efforts have already made it possible to very significantly improve the environmental performance of airplanes. The Applicant takes into consideration the factors affecting all the design and development phases, to obtain aerospace components and substances that consume less energy, are more environmentally friendly, and whose integration and use in civil aviation have moderate environmental impacts, with the aim of improving the energy efficiency of these aircraft.

Thus, to improve the propulsive efficiency of the propulsion system and reduce its specific fuel consumption as well as the noise emitted by the fan section, provision has been made for propulsion systems having a high bypass ratio BPR (corresponding to the ratio of the flow rate of the secondary air stream to the flow rate of the primary air stream). To achieve such bypass ratios, the fan section can be uncoupled from the low-pressure turbine, thus making it possible to independently optimize their respective rotation speeds. Generally, the uncoupling is done using a reduction mechanism placed between the upstream end of the low-pressure shaft and a rotor of the fan section. The rotor of the fan section is then driven by the low-pressure shaft by way of the reduction mechanism at a rotation speed less than that of the low-pressure shaft.

However, the increase in the rotation speed of the low-pressure turbine has an impact on the dynamics of the low-pressure spool and in particular on the deformation modes of the low-pressure shaft. This impact is even greater when one is seeking to increase the efficiency of the low-pressure turbine.

### SUMMARY

One aim of this application is to optimize the performance of the aeronautical propulsion system, particularly in terms of specific fuel consumption while controlling the dynamic behavior of the low-pressure spool.

For this purpose provision is made, according to a first aspect, for an aeronautical propulsion system comprising:
a fan rotor configured to be driven by a fan shaft;
a drive turbine configured to drive the fan rotor by way of a drive shaft about an axis of rotation;
a reduction mechanism coupling the drive shaft and the fan shaft to drive the fan shaft at a rotation speed less than the rotation speed of the drive shaft;
bearings configured to center the drive shaft with respect to the axis of rotation, the bearings comprising one front bearing extending upstream of a combustion chamber of the propulsion system and two rear bearings extending downstream of the combustion chamber, in which a position of the bearings in the propulsion system obeys the following formula:

$$\frac{{R}_{m}}{{d}_{2}} \geq C * XN * \frac{{d}_{1}^{2}}{{R}_{11 b}} * 1 {0}^{- 11} - {E}_{1}$$

where: d₂ is the distance between the centers of gravity of the rear bearings of the drive shaft, in millimeters (mm);
Rₘ is an average radius of the drive turbine, in millimeters (mm);
XN is the redline speed of the drive shaft, in revolutions per minute (rpm);
d₁ is the distance between the center of gravity of the front bearing and the center of gravity of the rear bearing nearest to the front bearing, in millimeters (mm);
R_{11b} is an average radius of the rear bearing nearest to the front bearing, in millimeters (mm); and
C=170 (mm*rpm)⁻¹, E₁=0.18.

Certain preferred but non-limiting features of the propulsion system according to the first aspect are as follows, taken individually or in combination:
the bearings are also positioned in the propulsion system such as to obey the following formula:

$$\frac{{R}_{m}}{{d}_{2}} \leq C * XN * \frac{{d}_{1}^{2}}{{R}_{11 b}} * 1 {0}^{- 11} + {E}_{2}$$

where E₂=0.378;
the redline speed of the drive shaft obeys the following formula:

$$XN \geq A * \frac{{R}_{11 b}}{{d}_{1}^{2}} * 1 {0}^{5}$$

where A=5 500 mm*rpm;
the redline speed of the drive shaft obeys the following formula:

$$XN \leq B * \frac{{R}_{11 b}}{{d}_{1}^{2}} * 1 {0}^{5}$$

where B=8 500 mm*rpm;
all or part of the bearings of the drive shaft are associated with a bearing mode damper;
the bearing mode dampers comprise damping by pressurized fluid film;
each bearing mode damper comprises a deformable cage mounted between a ring of the associated bearing and a stator part of the propulsion system;
the bearings of the drive shaft comprise at least one front bearing and exactly two rear bearings;
the propulsion system further comprises an additional turbine configured to drive an additional compressor by way of an additional shaft, the additional shaft being configured to rotate at a higher speed than the drive shaft about the axis of rotation, the additional turbine being two-stage;
an average radius of a bore of the additional turbine obeys the following formula:

$${R}_{m \_ a} \leq E * {L}_{HP}^{2} * XN * 1 {0}^{- 9} + {F}_{1}$$

where: R_{m_a} is the average radius of the bore of the additional turbine in millimeters (mm); L_{HP} is a distance between an inlet of the additional compressor and an outlet of the additional turbine in millimeters (mm); and E=3.15 (mm·rpm)⁻¹ and F₁=23 millimeters (mm);
an average radius of a bore of the additional turbine obeys the following formula:

$${R}_{m \_ a} \geq E * {L}_{HP}^{2} * XN * 1 {0}^{- 9} + {F}_{2}$$

where: R_{m_a} is the average radius of the bore of the additional turbine in millimeters; L_{HP} is a distance between an inlet of the additional compressor and an outlet of the additional turbine in millimeters (mm); and E=3.15 (mm·rpm)⁻¹ and F₂=13 millimeters (mm);
an average radius of a bore of the additional turbine obeys the following formula:

$${R}_{m \_ a} \leq K * {( L * \sqrt{\frac{{D}_{9}^{2}}{BPR + 1} * {( {T}_{e} + {T}_{r e f} )}^{0.5 - \frac{GAMMA}{GAMMA - 1}} * 1 {0}^{3}} * n + M )}^{2} * XN * 1 {0}^{- 9} + {N}_{1}$$

where: D is the diameter of the fan rotor in millimeters, measured in a plane normal to the axis of rotation at the level of an intersection between a tip and a leading edge of the blades of the fan rotor; BPR is the bypass ratio of the propulsion system and is measured when the propulsion system is static at takeoff rating in a standard atmosphere and at sea level; Tₑ is the temperature at the inlet of the drive turbine when the propulsion system is static at takeoff rating in a standard atmosphere and at sea level and is expressed in degrees Celsius (° C.); T_{ref}=273 K; n is the number of stages in the additional turbine and the additional compressor; GAMMA is the adiabatic coefficient of air; and K=6.76, L=153.6 m⁻¹. (° C.)^{-1/2}·(rpm)⁻¹, M=421 mm·(° C.)^{1/2} and N₁=−11 millimeters (mm);
an average radius of a bore of the additional turbine obeys the following formula:

$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * 1 {0}^{3}} * n + M )}^{2} * XN * 1 {0}^{- 9} + {N}_{2}$$

where: D₉ is the diameter of the fan rotor in millimeters, measured in a plane normal to the axis of rotation at the level of an intersection between a tip and a leading edge of the blades of the fan rotor; BPR is the bypass ratio of the propulsion system and is measured when the propulsion system is static at takeoff rating in a standard atmosphere and at sea level; Tₑ is the temperature at the inlet of the drive turbine when the propulsion system is static at takeoff rating in a standard atmosphere and at sea level and is expressed in degrees Celsius (° C.); T_{ref}=273 K; n is the number of stages in the additional turbine and the additional compressor; GAMMA is the adiabatic coefficient of air; and K=6.76, L=153.6 m⁻¹·(° C.)^{-1/2}·(rpm)⁻¹, M=421 mm·(° C.)^{1/2} and N₂=−21 millimeters (mm);
an average radius of the bore of the additional turbine is at least equal to:

$${R}_{m \_ a} \geq G * FN * BPR * {10}^{- 4} + H$$

where: R_{m_a} is the average radius of the bore of the additional turbine in millimeters; FN is the thrust of the fan rotor measured when the propulsion system is static at takeoff rating in a standard atmosphere and at sea level and is expressed in Newton (N); BPR is the bypass ratio of the propulsion system and is measured when the propulsion system is static at takeoff rating in a standard atmosphere and at sea level; and G=0.16 millimeters per Newton (mm/N) and H=18 millimeters (mm);
an average radius of the bore of the high-pressure turbine is at the most equal to:

$${R}_{m \_ a} \leq I * FN * BPR * 1 {0}^{- 4} + J$$

where: R_{m_a} is the average radius of the bore of the additional turbine in millimeters (mm); FN is the thrust of the fan rotor measured when the propulsion system is static at takeoff rating in a standard atmosphere and at sea level and is expressed in Newton (N); BPR is the bypass ratio of the propulsion system and is measured when the propulsion system is static at takeoff rating in a standard atmosphere and at sea level; and I=0.16 millimeters per Newton (mm/N) and J=28 millimeters;
the additional compressor comprises at least eight stages and at the most eleven stages;
the drive turbine comprises at least three stages and at the most five stages; and/or
a reduction ratio of the reduction mechanism is greater than or equal to 2.5 and less than or equal to 11.

According to a second aspect, provision is made for an aircraft comprising at least one propulsion system according to the first aspect, attached to the aircraft by way of a pylon.

According to a third aspect, provision is made for a method for dimensioning or manufacturing a propulsion system comprising a reduction mechanism coupling a drive shaft and a fan rotor to drive the fan rotor at a speed less than a speed of the drive shaft, and bearings configured to center the drive shaft with respect to the axis of rotation, the bearings comprising one front bearing extending upstream of a combustion chamber of the propulsion system and two rear bearings extending downstream of the combustion chamber,
the propulsion system being dimensioned such that a position of the bearings in the propulsion system obeys the following formula:

$$\frac{{R}_{m}}{{d}_{2}} \geq C * XN * \frac{{d}_{1}^{2}}{{R}_{11 b}} * 1 {0}^{- 11} - {E}_{1}$$

where: d₂ is the distance between the centers of gravity of the rear bearings of the drive shaft, in millimeters (mm);
   Rₘ is an average radius of the drive turbine, in millimeters (mm);
   XN is the redline speed of the drive shaft, in revolutions per minute (rpm);
   d₁ is the distance between the center of gravity (G₁₁ₐ) of the front bearing and the center of gravity of the rear bearing nearest to the front bearing, in millimeters (mm);
   R_{11b} is an average radius of the rear bearing nearest to the front bearing in millimeters; and
   C=170 (mm*rpm)⁻¹, E₁=−0.18.

Certain preferred but non-limiting features of the method for dimensioning or manufacturing a propulsion system according to the third aspect, in which the propulsion system is dimensioned such that the bearings are also positioned in the propulsion system so as to obey the following formula:

$$\frac{{R}_{m}}{{d}_{2}} \leq C * XN * \frac{{d}_{1}^{2}}{{R}_{11 b}} * 1 {0}^{- 11} + {E}_{2}$$

where E₂=0.378;
   the propulsion system is moreover dimensioned such that the redline speed of the drive shaft obeys the following formula:

$$XN \geq A * \frac{{R}_{11 b}}{{d}_{1}^{2}} * 1 {0}^{5}$$

where A=5 500 mm*rpm;
   the propulsion system is also dimensioned such that the redline speed of the drive shaft moreover obeys the following formula:

$$XN \leq B * \frac{{R}_{11 b}}{{d}_{1}^{2}} * 1 {0}^{5}$$

where B=8 500 mm*rpm;
   the propulsion system further comprises an additional turbine configured to drive a compressor by way of an additional shaft, the additional shaft being configured to rotate at a higher speed than the drive shaft about the axis of rotation, an average radius of a bore of the additional turbine obeys the following formula:

$${R}_{m \_ a} \leq E * {L}_{HP}^{2} * XN * 1 {0}^{- 9} + {F}_{1}$$

where: R_{m_a} is the average radius of the bore of the additional turbine in millimeters (mm); L_{HP} is a distance between an inlet of the additional compressor and an outlet of the additional turbine in millimeters (mm); and E=3.15 (mm·rpm)⁻¹ and F₁=23 millimeters (mm);
   the propulsion system further comprises an additional turbine configured to drive a compressor by way of an additional shaft, the additional shaft being configured to rotate at a higher speed than the drive shaft about the axis of rotation, an average radius of a bore of the additional turbine obeys the following formula:

$${R}_{m \_ a} \geq E * {L}_{HP}^{2} * XN * 1 {0}^{- 9} + {F}_{2}$$

where: R_{m_a} is the average radius of the bore of the additional turbine in millimeters (mm); L_{HP} is a distance between an inlet of the additional compressor and an outlet of the additional turbine in millimeters (mm); and E=3.15 (mm·rpm)⁻¹ and F₂=13 millimeters (mm);
   the propulsion system further comprises an additional turbine configured to drive a compressor by way of an additional shaft, the additional shaft being configured to rotate at a higher speed than the drive shaft about the axis of rotation, an average radius of a bore of the additional turbine obeys the following formula:

$${R}_{m \_ a} \leq K * {( L * \sqrt{\frac{{D}_{9}^{2}}{BPR + 1} * {( {T}_{e} + {T}_{ref} )}^{0.5 - \frac{GAMMA}{GAMMA - 1}} * 1 {0}^{3}} * n + M )}^{2} * XN * 1 {0}^{- 9} + {N}_{1}$$

where: D₉ is the diameter of the fan rotor in millimeters, measured in a plane normal to the axis of rotation at the level of an intersection between a tip and a leading edge of the blades of the fan rotor; BPR is the bypass ratio of the propulsion system and is measured when the propulsion system is static at takeoff rating in a standard atmosphere and at sea level; Tₑ is the temperature at the inlet of the drive turbine when the propulsion system is static at takeoff rating in a standard atmosphere and at sea level and is expressed in degrees Celsius (° C.); T_{ref}=273 K; n is the number of stages in the additional turbine and the additional compressor; GAMMA is the adiabatic coefficient of air; and K=6.76, L=153.6 m⁻¹·(° C.)^{-1/2}·(rpm)⁻¹, M=421 mm·(° C.)^{1/2} and N₁=−11 millimeters (mm);
   the propulsion system further comprises an additional turbine configured to drive a compressor by way of an additional shaft, the additional shaft being configured to rotate at a higher speed than the drive shaft about the axis of rotation, an average radius of a bore of the additional turbine obeys the following formula:

$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * 1 {0}^{3}} * n + M )}^{2} * XN * 1 {0}^{- 9} + {N}_{2}$$

where: D₉ is the diameter of the fan rotor in millimeters, measured in a plane normal to the axis of rotation at the level of an intersection between a tip and a leading edge of the blades of the fan rotor; BPR is the bypass ratio of the propulsion system and is measured when the propulsion system is static at takeoff rating in a standard atmosphere and at sea level; Tₑ is the temperature at the inlet of the drive turbine when the propulsion system is static at takeoff rating in a standard atmosphere and at sea level and is expressed in degrees Celsius (° C.); T_{ref}=273 K; n is the number of stages in the additional turbine and the additional compressor; GAMMA is the adiabatic coefficient of air; and K=6.76, L=153.6 m⁻¹·(° C.)^{-1/2}·(rpm)⁻¹, M=421 mm·(° C.)^{1/2} and N₂=−21 millimeters (mm);
   the propulsion system further comprises an additional turbine configured to drive a compressor by way of an additional shaft, the additional shaft being configured to rotate at a higher speed than the drive shaft about the axis of rotation, an average radius of a bore of the additional turbine being at least equal to:

$${R}_{m \_ a} \geq G * FN * BPR * 1 {0}^{- 4} + H$$

where: R_{m_a} is the average radius of the bore of the additional turbine in millimeters (mm); FN is the thrust of the fan rotor measured when the propulsion system is static at takeoff rating in a standard atmosphere and at sea level and is expressed in Newton (N); BPR is the bypass ratio of the propulsion system and is measured when the propulsion system is static at takeoff rating in a standard atmosphere and at sea level; and G=0.16 millimeters per Newton (mm/N) and H=18 millimeters (mm); and/or
   the propulsion system further comprises an additional turbine configured to drive a compressor by way of an additional shaft, the additional shaft being configured to rotate at a higher speed than the drive shaft about the axis of rotation, an average radius of the bore of the high-pressure turbine being at the most equal to:

$${R}_{m \_ a} \leq I * FN * BPR * {10}^{- 4} + J$$

where: R_{m_a} is the average radius of the bore of the additional turbine in millimeters (mm); FN is the thrust of the fan rotor measured when the propulsion system is static at takeoff rating in a standard atmosphere and at sea level and is expressed in Newton (N); BPR is the bypass ratio of the propulsion system and is measured when the propulsion system is static at takeoff rating in a standard atmosphere and at sea level; and I=0.16 millimeters per Newton (mm/N) and J=28 millimeters.

According to a fourth aspect, provision is made for a method for manufacturing an aeronautical propulsion system comprising the following steps:
dimensioning the aeronautical propulsion system in accordance with the dimensioning method according to the third aspect; and
manufacturing the aeronautical propulsion system.

### DESCRIPTION OF THE FIGURES

Other features, aims and advantages will become apparent from the following description, which is purely illustrative and non-limiting, and which must be read with reference to the appended drawings wherein:

FIG. 1 is a schematic partial and section view of an example of a propulsion system in accordance with a first embodiment, in which the fan section is ducted;

FIG. 2 is a schematic partial and section view of an example of a propulsion system in accordance with a first embodiment, in which the fan section is unducted;

FIG. 3 is a schematic section view of an example of a reduction mechanism in a first variant;

FIG. 4 is a schematic section view of an example of a reduction mechanism in a second variant;

FIG. 5 is an example of an aircraft which may comprise at least one propulsion system in accordance with the first or second embodiment;

FIG. 6 is a flow chart illustrating examples of steps of a dimensioning or manufacturing method.

On all the figures, similar elements bear identical reference numbers.

### DETAILED DESCRIPTION OF THE INVENTION

A propulsion system 1 has a main direction extending along a longitudinal axis X and comprises, from upstream to downstream in the direction of flow of the gas in the propulsion system 1 when it is in operation, a fan section 2 and a primary spool 3, often known as the “gas generator”, including a compressor section 4, 5, a combustion chamber 6 and a turbine section 7, 8. The propulsion system 1 here is an aeronautical propulsion system 1 configured to be attached to an aircraft 100 by way of a pylon (or mast).

The compressor section 4, 5 comprises a series of stages each comprising a wheel of movable blades (rotor) 4a, 5a rotating in front of a wheel of fixed blades (stator) 4b, 5b. The turbine section 7, 8 also comprises a series of stages each comprising a wheel of fixed blades (stator) 7b, 8b behind which rotates a wheel of movable blades (rotor) 7a, 8a.

In this application, the axial direction corresponds to the direction of the longitudinal axis X, in correspondence with the rotation of the shafts of the gas generator, and a radial direction is a direction perpendicular to this axis X and passing through it. Moreover, the circumferential (or lateral, or tangential) direction corresponds to a direction perpendicular to the longitudinal axis X and not passing through it. Unless otherwise specified, inner (or interior respectively) and outer (or exterior respectively) are used with reference to a radial direction such that the inner part or face of an element is nearer to the axis X than the outer part or face of the same element.

In operation, a stream of air F entering the propulsion system 1 is divided between a primary stream of air F1 and a secondary stream of air F2, which circulate from upstream to downstream in the propulsion system 1.

The secondary air stream F2 (also known as “bypass air stream” flows around the primary spool 3. The secondary air stream F2 is used to cool the periphery of the primary spool 3 and serves to generate most of the thrust provided by the propulsion system 1.

The primary air stream F1 flows through a primary air path inside the primary spool 3, passing successively through the compressor section 4, 5, the combustion chamber 6 where it is mixed with fuel to serve as comburent, and the turbine section 7, 8. The passing of the primary air stream F1 through the turbine section 7, 8 receiving energy from the combustion chamber 6, causes the rotation of the rotor of the turbine section 7, 8, which in turn causes the rotation of the rotor of the compressor section 4, 5 as well as a rotor part 9 of the fan section 2.

In a twin-spool propulsion system 1, the compressor section 4, 5 may comprise a low-pressure compressor 4 and a high-pressure compressor 5. The turbine section 7, 8 may comprise a high-pressure turbine 7 and a low-pressure turbine 8. The rotor of the high-pressure compressor 5 is rotationally driven by the rotor of the high-pressure turbine 7 by way of a high-pressure shaft 10. The rotor of the low-pressure compressor 4 and the rotor part 9 of the fan section 2 are rotationally driven by the rotor of the low-pressure turbine 8 by way of a low-pressure shaft 11. Thus, the primary spool 3 comprises a high-pressure spool comprising the high-pressure compressor 5, the high-pressure turbine 7 and the high-pressure shaft 10, and a low-pressure spool comprising the fan section 2, the low-pressure compressor 4, the low-pressure turbine 8 and the low-pressure shaft 11. The speed of rotation of the high-pressure spool is greater than the speed of rotation of the low-pressure spool. In a three-spool propulsion system 1, the turbine section 7, 8 further comprises an intermediate turbine, positioned between the high-pressure turbine 7 and the low-pressure turbine 8 and configured to drive the rotor of the low-pressure compressor 4 by way of an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a segment of its length, in the high-pressure shaft 10 and is coaxial with the high-pressure shaft 10. The low-pressure shaft 11 and the high-pressure shaft 10 can be corotational, i.e. be driven in the same direction about the longitudinal axis X. In a variant, the low-pressure shaft 11 and the high-pressure shaft are contrarotating, i.e. driven in opposite directions about the longitudinal axis X. Optionally, the intermediate shaft is housed between the high-pressure shaft 10 and the low-pressure shaft 11. The intermediate shaft and the low-pressure shaft 11 can be corotating or contrarotating.

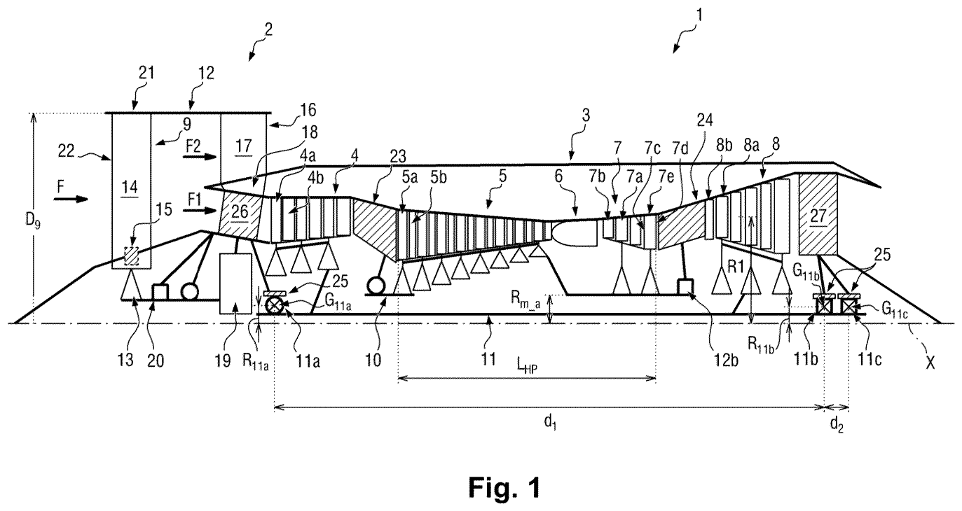

The fan section 2 comprises at least the fan rotor 9 suitable for being rotationally driven with respect to a stator part of the propulsion system 1 by the turbine section 7, 8. Each fan rotor 9 comprises a hub 13 and blades 14 extending radially from the hub 13. The blades 14 of each rotor 9 may be fixed with respect to the hub 13 or have variable setting. In this case, the root of each of the blades 14 of each rotor 9 is mounted pivotably along an axis of setting and is connected to a pitch change mechanism 15 mounted in the propulsion system 1, the setting being adjusted according to the flight phases by the pitch change mechanism 15. The pitch change mechanism 15 is illustrated in broken lines on FIG. 1 to show that this feature is optional.

The fan section 2 may further comprise a fan stator 16, or straightener, which comprises blades 17 mounted on a hub 16 of the fan stator and have the function of guiding the secondary air stream F2 which flows at the outlet of the fan rotor 9. The blades 17 of the fan rotor 18 can be fixed with respect to the hub or have a variable setting. Similarly to the blades 14 of the rotor, the root of each of the blades of the stator 17 is mounted pivotably along a setting axis X and is connected to a pitch change mechanism 15a, which is generally distinct from that of the fan rotor 9, the setting being adjusted according to the flight phases by the pitch change mechanism.

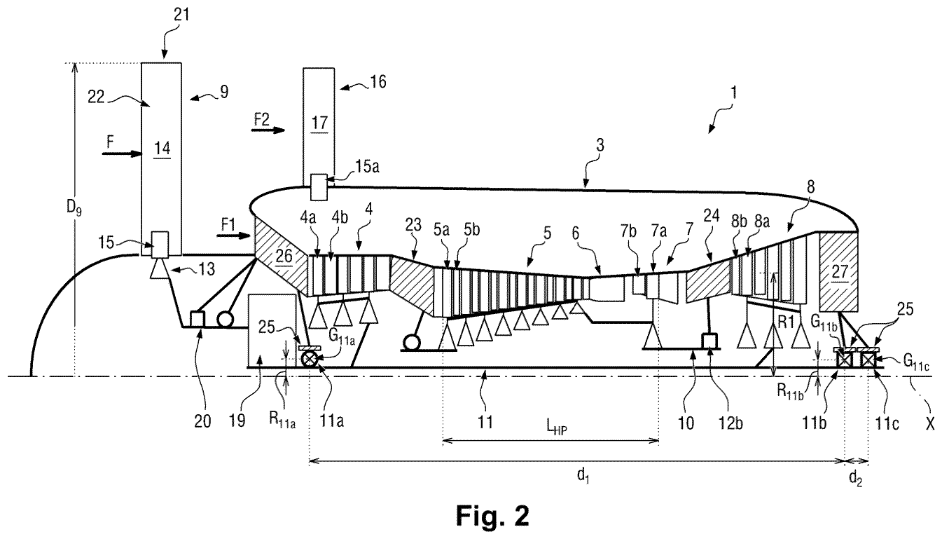

The diameter D₉ of the fan rotor 9 can then be between 2.032 meters (m) (80 inches) and 4.699 meters (m) (185 inches) inclusive, which makes it possible to obtain thrusts in the ranges described above. When the fan rotor 9 is ducted, the diameter D₉ is for example between 2.159 meters (m) (85 inches) and 3.048 meters (m) (120 inches) inclusive, for example equal to 2.286 meters (m) (90 inches), which allows the integration of the propulsion system 1 conventionally, in particular under the wing of an aircraft. When the fan rotor 9 is unducted, the diameter D₉ is for example greater than or equal to 2.54 meters (m) (100 inches), for example between 3.048 meters (m) 120 inches and 3.962 meters (m) (156 inches). The diameter D₉ of the fan rotor 9 is measured here in a plane normal to the axis X of rotation at the level of an intersection between a tip 21 and a leading edge 22 of the blades 14 of the fan rotor 9, and is expressed in meters. Note that since FIGS. 1 and 2 are partial views, the diameter Do is only partially visible.

The fan rotor 9 moreover comprises at least twelve blades 14 and at the most twenty-four blades 14, for example at least sixteen blades 14 and at the most twenty-two blades 14. The number of blades 16 in the fan stator 17 depends on the acoustic criteria defined for the propulsion system 1 and is at least equal to the number of blades 14.

In order to improve the propulsive efficiency of the propulsion system 1 and to reduce its specific fuel consumption as well as the noise emitted by the fan section 2, the propulsion system 1 has a high bypass ratio. The term “high bypass ratio” should here be understood to mean a bypass ratio greater than or equal to 10, for example between 10 and 80 inclusive. To compute the bypass ratio, the mass flow rate of the secondary air stream F2 and the mass flow rate of the primary air stream F1 are measured when the propulsion system 1 is static, uninstalled, at takeoff rating in a standard atmosphere (as defined by the International Civil Aviation Organization (ICAO), Doc 7488/3, 3^{rd} edition) and at sea level (so-called SLS, for Sea Level Standard, conditions). Note that, in this application, the parameters (pressure, flow rate, thrust speed, etc.) are systematically determined under these conditions. The term “uninstalled” should here be understood to mean that the measurements are taken when the propulsion system 1 is in a test bed (and not installed on an aircraft 100), the measurements then being easier to take. The distances (length, radius, diameter, etc.) are on the other hand measured at ambient temperature (approximately 20° C.) when the propulsion system 1 is cool, i.e. when the propulsion system 1 has been stopped for long enough that the parts of the propulsion system are at ambient temperature, it being understood that these dimensions vary little from the conditions under which the propulsion system 1 is at takeoff rating.

The fan rotor 9 is uncoupled from the low-pressure shaft 11 using a reduction mechanism 19, placed between an upstream end of the low-pressure shaft 11 and the fan rotor 9, to independently optimize their respective rotation speeds. In this scenario, the propulsion system 1 further comprises an additional shaft, the so-called fan shaft 20. The low-pressure shaft 11 connects the low-pressure turbine 8 to an input of the reduction mechanism 19 while the fan shaft 20 connects the output of the reduction mechanism 19 to the fan rotor 9. The fan rotor 9 is therefore driven by the low-pressure shaft 11 by way of the reduction mechanism 19 and by way of the fan shaft 20 at a rotation speed less than the rotation speed of the low-pressure turbine 8.

This uncoupling makes it possible to reduce the rotation speed and the pressure ratio of the fan rotor 9 and to increase the power extracted by the low-pressure turbine 8. Specifically, the global efficiency of propulsion systems is first-order conditional on the propulsive efficiency, which is favorably influenced by minimization of the variation in the kinetic energy of the air as it passes through the propulsion system 1. In a propulsion system 1 with a high bypass ratio, most of the flow rate generating the propulsive force is formed by the secondary air stream F2 of the propulsion system 1, the kinetic energy of the secondary air stream F2 being mainly affected by the compression undergone by the secondary air stream F2 when it passes through the fan section 2. The propulsive efficiency and the pressure ratio of the fan section 2 are therefore related: the lower the pressure ratio of the fan section 2, the better the propulsion efficiency. To optimize the propulsion efficiency of the propulsion system 1, the pressure ratio of the fan, which corresponds to the ratio of the average pressure at the outlet of the fan stator 17 (or, if there is no stator, of the fan rotor 9) and the average pressure at the inlet of the fan rotor 9, is less than or equal to 1.70, for example less than or equal to 1.50, for example between 1.05 and 1.45. The average pressures are measured here over the height of the blade 14 (of the surface that radially delimits inside the air flow path at the inlet of the fan rotor 9 to the tip 21 of the fan blade 14).

The propulsion system 1 is configured to provide a thrust between 18 000 lbf (80 068 N) and 51 000 lbf (22 2411 N), for example between 20 000 lbf (88964 N) and 35 000 lbf (15 5688 N).

The fan section 2 can be ducted or unducted. In the case of a ducted fan section 2, the fan section 2 comprises a fan casing 12 and the fan rotor 9 is housed in the fan casing 12.

A ducted fan section 2 comprises a fan rotor 9 extending upstream of a fan stator. The blades of the fan stator are then generally referred to as Outlet Guide Vanes (OGV) and have a fixed setting with respect to the hub of the fan stator. Moreover, the bypass ratio of the propulsion system 1 is for example greater than or equal to 10, for example between 10 and 35 inclusive, for example between 10 and 18 inclusive. The peripheral speed at the tip 21 of the blades of the fan rotor 9 can moreover be between 260 m/s and 400 m/s. The blades 14 of the fan rotor 9 can be fixed or have a variable setting. The fan pressure ratio can then be between 1.20 and 1.45.

In an unducted fan section 2, the fan section 2 (which can also be referred to by the term propeller) is not surrounded by a fan casing. The fan section 2 being unducted, the blades 14 of the fan rotor 9 have a variable setting. Propulsion systems comprising at least one unducted fan rotor 9 are known by the terms “open rotor” or “unducted fan”. The propulsion system 1 may comprise two unducted and contrarotating fan rotors 9. Such a propulsion system 1 is known as CROR for Contra-Rotating Open Rotor or UDF for Unducted Double Fan. The fan rotor or rotors 9 may be placed aft of the primary spool 3 such as to be of push type or forward of the primary spool 3 such as to be of pull type. In a variant, the propulsion system 1 may comprise a single unducted fan rotor 9 and an unducted fan stator 16 (straightener). Such a propulsion system 1 is known as USF for Unducted Single Fan. In the case of a propulsion system 1 of USF type, the blades 17 of the straightener 16 are rotationally fixed with respect to the axis X of rotation of the fan rotor 9 upstream and consequently do not undergo any centrifugal force. The blades 17 of the straightener 16 also have variable setting.

The elimination of the ducting around the fan section 2 makes it possible to increase the bypass ratio very significantly without the propulsion system 1 being penalized by the mass of the casings or nacelles intended to surround the fan section 2. The bypass ratio of the propulsion system 1 comprising an unducted fan section 2 is thus greater than or equal to 40, for example between 40 and 80 inclusive. The peripheral speed at the tip 21 of the blades 14 of the rotor(s) of the fan 9 can moreover be between 210 m/s and 260 m/s. The fan pressure ratio can then be, for example, between 1.05 and 1.20.

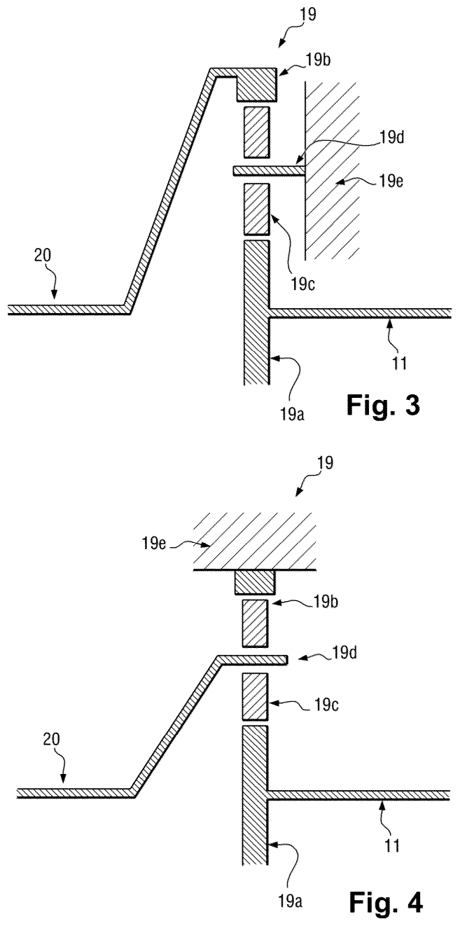

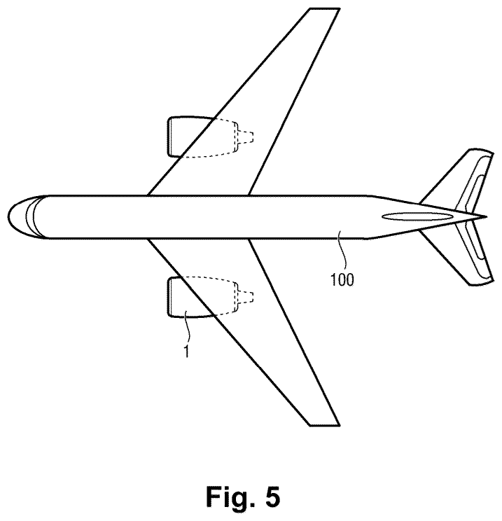

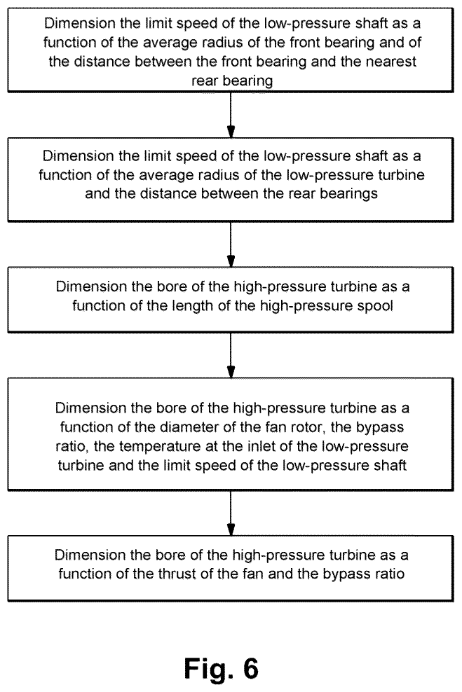

The reduction mechanism 19 may for example comprise a reduction mechanism 19 with a planetary gear train, for example of “planetary” type or “star” type, one-stage or two-stage. According to a first variant, the reduction mechanism 19 can be of “star” type (FIG. 3) and comprise a sun gear 19a (input of the reduction mechanism 19), centered on an axis X of rotation of the reduction mechanism 19 (generally colinear with the longitudinal axis X) can configured to be rotationally driven by the low-pressure shaft 11, a ring gear 19b (output of the reduction mechanism 19) coaxial with the sun gear 19a and configured to rotationally drive the fan shaft 20 about the axis X of rotation, and a series of satellites 19c circumferentially distributed around the axis X of rotation between the sun gear 19a and the ring gear 19b, each satellite 19c being internally meshed with the sun gear 19a and externally meshed with the ring gear 19b. The series of satellites 19c is mounted on a planet-carrier 19d which is fixed with respect to a stator part 19e of the propulsion system 1, for example with respect to a casing of the compressor section 4, 5. In a second variant, the reduction mechanism 19 can be of planetary type (FIG. 4), in which case the ring gear 19b is mounted fixedly on the stator part 19e of the propulsion system 1 and the fan shaft 20 is rotationally driven by the planet carrier 19d (which is therefore rotationally movable with respect to a stator part 19e of the propulsion system 1, for example with respect to a casing of the compressor section 4, 5).

Whatever the configuration of the reduction mechanism 19, the diameter of the ring gear 19b and of the planet-carrier 19d are greater than the diameter of the sun gear 19a, such that the rotation of the fan rotor 9 is less than the rotation speed of the low-pressure shaft 11.

The reduction ratio of the reduction mechanism 19 is greater than or equal to 2.5 and less than or equal to 11. In the case of a propulsion system 1 comprising a ducted fan rotor 9, the reduction ratio can be greater than or equal to 6.0, typically around 3.0. In the case of a propulsion system 1 comprising an unducted fan rotor, the reduction ratio can be between 9.0 and 11.0.

The low-pressure shaft 11 is supported by three or four bearings 11a, 11b and/or 11c, in order to control the deformation modes of the low-pressure shaft 11. The low-pressure shaft 11 may thus comprise one or two front bearings 11a, which extend upstream of the combustion chamber 6, and two rear bearings 11b, 11c, which extend downstream of the combustion chamber 6. The bearings 11a, 11b, 11c comprise an inner ring mounted the low-pressure shaft 11 and an outer ring mounted on a stator part of the propulsion system 1, typically on a casing of the propulsion system 1 through which forces travel through the propulsion system 1. Thus, a first front bearing 11a can be mounted on the one hand on the low-pressure shaft 11 and on the other hand on an inlet casing 26 of the propulsion system 1, which extends between the fan rotor 9 and the low-pressure compressor 4. Where applicable, a second front bearing can be mounted on the one hand on the low-pressure shaft 11 and on the other hand on an inter-compressor casing 23 (or intermediate casing) or on the inlet casing 26 of the propulsion system 1, or between the low-pressure compressor 4 and the high-pressure compressor 5. A first rear bearing 11b can be mounted on the one hand on the low-pressure shaft 11 and on the other hand on the inter-turbine casing 24 (i.e. on the casing extending between the high-pressure turbine 7 and the low-pressure turbine 8), upstream of the low-pressure turbine 8. In a variant, the first rear bearing 11b can be mounted on the exhaust casing 27, which extends immediately downstream of the low-pressure turbine 8. The first rear bearing 11b extends downstream of the bearing 12b the furthest downstream of the high-pressure shaft 10. The second rear bearing 11c can be mounted on the exhaust casing 27 or, if the integration allows it, on the inter-turbine casing. Where applicable, the first and the second rear casing 11b, 11c can be mounted on one and the same cylindrical shell, which is itself attached to the exhaust casing 27.

In one form of embodiment, the low-pressure shaft 11 is supported by one front bearing 11a and two rear bearings 11b, 11c.

The twin-spool propulsion system 1 may particularly comprise a two-stage high-pressure turbine 7, a high-pressure compressor 5 comprising at least eight stages and at the most eleven stages, a low-pressure turbine 8 comprising at least three stages and at the most five stages and a low-pressure compressor 4 comprising at least two stages and at the most four stages.

The presence of the reduction mechanism 19 between the low-pressure shaft 11 and the fan shaft 20 makes it possible to significantly increase the rotation speed of the low-pressure spool (which comprises the low-pressure turbine 8, the low-pressure shaft 11 and where applicable the low-pressure compressor 4 in the case of a twin-spool propulsion system), by comparison with a direct-drive engine (in which the fan shaft 20 is driven directly by the low-pressure shaft 11 and rotates at the same rotation speed as the low-pressure shaft 11) and to reduce the number of stages in the low-pressure turbine 8. This makes it possible to reduce the radial and axial bulk of the low-pressure turbine 8 as well as its mass, which improves the specific fuel consumption of the propulsion system 1. In parallel, the reduction of the fan pressure ratio reduces the amount of energy needed to drive the fan rotor 9, such that the flow rate at the inlet of the high-pressure compressor 5 and therefore the inlet section of the high-pressure compressor 5 may be reduced. This does however have the consequence of limiting the available space for the low-pressure shaft 11 (since the low-pressure shaft 11 is housed within the high-pressure shaft 10) and therefore contributes to the reduction of the diameter of the low-pressure shaft 11.

These modifications of the propulsion system 1 have the effect of modifying the deformation modes of the low-pressure shaft 11. As a result, the low-pressure shaft 11 is liable to exceed a redline speed and enter resonance within the operating ranges of the low-pressure spool. At resonance, which occurs at the transition to the redline speed of the low-pressure shaft 11, the latter undergoes overvoltage phenomena which amplify the deformations and forces caused by the (inevitable) unbalances of the low-pressure spool.

To control the dynamic behavior of the low-pressure shaft 11 and to move the deformation modes of the low-pressure shaft 11 to within an operating range of the low-pressure spool that is not liable to damage the propulsion system 1, the bearings 11a, 11b, 11c of the low-pressure shaft 11 are placed radially and axially such as to obey the following formula:

$$\frac{{R}_{m}}{{d}_{2}} \geq C * XN * \frac{{d}_{1}^{2}}{{R}_{11 b}} * 1 {0}^{- 11} - {E}_{1} \qquad ( 1 )$$

where: d₂ is the distance between the centers of gravity G_{11b} and G_{11c} of the rear bearings 11b, 11c of the low-pressure shaft 11, in millimeters (mm);
   Rₘ is an average radius of the low-pressure turbine 8, in millimeters (mm);
   XN is the redline speed of the low-pressure shaft (11), in revolutions per minute (rpm);
   d₁ is the distance between the center of gravity G₁₁ₐ of the front bearing 11a and the center of gravity G_{11b} of the rear bearing 11b nearest to the front bearing 11a, in millimeters (mm);
   R_{11b} is an average radius of the rear bearing 11b nearest to the front bearing 11a, in millimeters (mm); and
   C=170 (mm*rpm)⁻¹, E₁=0.18 (dimensionless).
   d₁, d₂, Rₘ, R_{11b}, and D₉ being distances, these parameters are determined when the propulsion system 1 (and therefore the fan section 2) is cool, as specified above.

The average radius Rₘ of the low-pressure turbine 8 corresponds to the mean of the average radii of the rotors 8a (wheels of movable blades) of the low-pressure turbine 8. In a given stage, the average radius R1 of a rotor 8a is equivalent to the mean between the outer radius of the rotor 8a and the inner radius of the rotor 8a, where the outer radius and the inner radius are measured between the axis of rotation X and the inner radial surface of the rotor 8a (which radially delimits, on the inside, the blade of the rotor 8a), when the propulsion system 1 is cool. Note that the outer radius and the inner radius are both measured in a plane normal to the axis of rotation X of the low-pressure turbine 8 at mid-distance between the leading edge 8c at the tip of the movable blades and the trailing edge 8d at the tip of the movable blades (i.e. at 50% of the chord at the blade tip), between the axis of rotation X and the outer radial surface of the rotor 8a (which radially delimits, on the outside, the blade of the rotor 8a).

The average radius R_{11b} of the rear bearing 11b (respectively R₁₁ₐ of the front bearing 11a) corresponds to the distance, measured in a plane normal to the longitudinal axis X, between the axis X and the center of gravity G_{11b} of the rear bearing 11b nearest to the front bearing 11a, i.e. the furthest upstream (respectively the center of gravity G₁₁ₐ of the rear bearing 11a). Note here that a bearing comprises an outer ring and an inner ring which are coaxial as well as bearings (balls, rollers etc.) mounted between the inner ring and the outer ring and configured to allow a relative motion of the inner ring with respect to the outer ring. The inner ring is mounted on the low-pressure shaft 11 and rotationally driven by the low-pressure shaft 11; the outer ring is mounted on a stator part (inlet casing 26, inter-compressor casing 23, inter-turbine casing 24, exhaust casing 27, etc.) of the propulsion system 1. The center of gravity of a bearing then corresponds to the center of gravity of the assembly formed by the inner ring, the outer ring and the bearings. When the inner ring and/or the outer ring is formed entirely and as a single part with a support (flange, shell, enclosure etc.) of the propulsion system 1 such that the ring cannot be differentiated from the support, the center of gravity is determined without taking into account the ring in question.

When the low-pressure shaft is supported by two front bearings upstream of the combustion chamber, the distance d₁ is measured between the front bearing 11a nearest to the combustion chamber 6 (i.e. the front bearing 11a furthest downstream) and the rear bearing 11b nearest to the combustion chamber 6 (i.e. the rear bearing 11b furthest upstream). In other words, the distance d₁ corresponds to the smallest distance between the centers of gravity of the front bearings 11a and of the rear bearings 11b.

When the low-pressure shaft 11 is supported by exactly two rear bearings 11b, 11c (and one or two front bearings 11a), the distance d₂ is measured between the centers of gravity G_{11b} and G_{11c} of these two bearings 11b and 11c. When the low-pressure shaft 11 is supported, in addition to the front bearing or bearings 11a, by exactly three rear bearings, the distance d₂ is measured between the bearing furthest upstream and the bearing furthest downstream of the rear bearings.

The redline speed XN corresponds to the absolute maximum speed liable to be encountered by the low-pressure shaft 11 throughout the entire flight (as per the European certification regulations EASA CS-E 740 (or as per the American certification regulations 14-CFR Part 33)). The redline speed corresponds to the maximum rotation speed when the propulsion system is healthy (and potentially at the end of its life). It is therefore liable to be reached by the low-pressure shaft 11 in flight conditions. This redline speed is part of the data declared in the type certificate data sheet. Specifically, this rotation speed is usually used as the reference speed for the dimensioning of propulsion systems 1 and in certain certification tests (such as blade loss or rotor integrity tests.)

The Applicant noticed that the position of the bearings 11a-11c of the low-pressure shaft 11 had an impact on the rigidity of fixing of the low-pressure shaft 11. In particular, the nearer the rear bearings 11a-11c to one another (small d₂), the more rigid the fixing of the low-pressure shaft 11, the lower the stiffness of the low-pressure shaft 11 and the smaller the deformation modes of the low-pressure shaft 11, which are therefore more liable to be located in the operating range of the low-pressure spool. Similarly, the larger the diameter of the shaft (which is proportional to the average radius of the rear bearing, R_{11b}) and/or the smaller the distance between the front and rear bearings (d₁), the lower the deformation modes. Thus, when the position of the bearings 11a-11c obeys the formula (1), the stiffness of the low-pressure shaft 11 increases enough to more rigidly fix the low-pressure shaft 11. Typically, for a propulsion system comprising a reduction mechanism 19, the first deformation mode of the low-pressure shaft 11 then occurs at a transient speed corresponding for example to a speed less than idle speed and is therefore not liable to damage the propulsion system 1. Thus, a transient speed is chosen that only occurs for a very short time during the operation of the propulsion system 1. For example, the propulsion system is dimensioned such that the redline speed corresponds to a speed occurring only at the beginning of start-up or at the end of shutdown of the propulsion system 1, such as a speed less than idle speed or greater than idle speed but outside a regular operating range or in an operating range which is very little used and transient during the operation of the propulsion system 1. The low-pressure shaft 11 can therefore be supercritical while having a controlled dynamic situation.

It is possible to modify the redline speed XN of the low-pressure shaft 11 by acting on the following elements of the propulsion system 1:

1. The shaft geometry (outer diameters and inner diameters). The outer diameter of the low-pressure shaft affects the design of the high-pressure spool, since the low-pressure shaft 11 passes through the high-pressure shaft 10 and restricts the bore radius of the high-pressure turbine 7. In addition, the variations in interior shape allowing an increase in the redline speed of the low-pressure shaft 11 are limited by the manufacturing constraints of the low-pressure shaft 11.

2. The material of the low-pressure shaft 11 (effect of Young modulus/density ratio). Conventionally, steels are used that have low variations in Young modulus. In a variant, the low-pressure shaft 11 can also be made of metal matrix composites, which have a Young modulus/density ratio that is markedly higher but an interface torque transmission capacity that is lower than conventional steels.

3. The number and position of the bearings 11a-11d of the low-pressure shaft 11. Specifically, an architecture in which the low-pressure shaft 11 is supported by four bearings makes it possible to increase the redline speed XN of the low-pressure shaft 11. The addition of a bearing by comparison with a three-bearing configuration does however increase the difficulty of integration. Where applicable, the rear bearings of the low-pressure shaft 11 can be integrated upstream of the low-pressure turbine 8, which makes it possible to increase the redline speed XN of the low-pressure shaft 11 at the expense of the engine length.

4. The stiffness of the trunnions between the rotors of the low-pressure spool. Specifically, increasing the stiffness of the trunnions makes it possible to increase the redline speed XN of the low-pressure shaft 11. However, the increase in stiffness of the trunnions also increase the difficulty of production and integration.

In the case of propulsion systems with a high bypass ratio (BPR) and a high overall pressure ratio (OPR), the outer diameter of the low-pressure shaft 11 and the distance between the low-pressure bearings are heavily restricted by the integration of the high-pressure spool, which leads to a supercritical dynamic situation which must be controlled. To avoid the length penalty related to the integration of bearings for the low-pressure shaft 11 upstream of the low-pressure turbine, an adjustment of the distance d₂ between the centers of gravity of the two rear bearings 11b, 11c of the low-pressure shaft 11 in accordance with the formulae (1) and (2) makes it possible to obtain the desired dynamic situation. The dimensioning of the redline speed XN so as to obey the formula (3) and (4) (see below) moreover makes it possible to optimize the integration of the high-pressure spool while remaining within accessible envelopes for the other parameters mentioned above.

Preferably, the bearings 11a, 11b, 11c of the low-pressure shaft 11 are placed radially and axially such as to obey the following formula:

$$\frac{{R}_{m}}{{d}_{2}} \leq C * XN * \frac{{d}_{1}^{2}}{{R}_{11 b}} * 1 {0}^{- 11} + {E}_{2} \qquad ( 2 )$$

where: E₂=0.378 (dimensionless).

When the position of the bearings 11a-11c obeys the formula (2), the bearings remain near enough to allow their integration underneath the low-pressure turbine 8 and/or the exhaust casing 27 of the propulsion system 1 and limits the axial length of the low-pressure spool and therefore the weight and bulk of the propulsion system 1.

Preferably, the propulsion system 11 is dimensioned such that a redline speed of the drive shaft 11 obeys the following formula:

$$X N \geq A * \frac{{R}_{11 b}}{{d}_{1}^{2}} * 1 {0}^{5} \qquad ( 3 )$$

where A=5 500 mm*rpm.

The redline speed XN of the low-pressure shaft 11 can for example be between 8 500 revolutions per minute and 12 000 revolutions per minute, preferably between 9 000 revolutions per minute and 11 000 revolutions per minute.

When the redline speed XN obeys the formula (3) and the rigidity of fixing of the bearings 11a-11c (i.e. the radial and axial position of the bearings 11a-11c) obeys the formula (1) and where applicable the formula (2), the redline speed is high enough to guarantee that the first mode of deformation of the low-pressure shaft 11 will be located in a range of rotation speed of the low-pressure shaft 11 in which the dynamic situation of the low-pressure shaft 11 can be controlled.

Preferably, the redline speed XN also obeys the following formula:

$$X N \leq B * \frac{{R}_{11 b}}{{d}_{1}^{2}} * 1 {0}^{5} \qquad ( 4 )$$

where B=8 500 mm*rpm.

When the low-pressure shaft 11 does not obey the formula (4), its redline speed becomes too high and entails an unfavorable dynamic situation of the turbine shaft.

Where applicable, in order to further improve the control of the dynamic situation and vibrational levels of the low-pressure shaft 11, the bearings 11a-11c of the low-pressure shaft 11 comprise a bearing mode damper 25 comprising a pressurized oil film configured to damp the mode transition (viscous damping). This type of damping is generally known by the term “squeeze film”. All or part of the bearings 11a-11c may also comprise a flexible cage, mounted between the outer ring and a rigid support fixedly secured to a stator part (inlet casing 26, inter-compressor casing 23, inter-turbine casing 24, exhaust casing 27, etc.) of the propulsion system 1 to control the stiffness of the bearings 11a-11c and refine the position of the first deformation mode. The cage comprises for this purpose a generally cylindrical wall mounted between the rigid support and the outer ring of the bearing and radially deformable studs in such a way as to permit a radial displacement of the generally cylindrical wall and therefore of the bearing 11a-11c with respect to the rigid support. Examples of bearings with flexible cages and pressurized fluid film damper comprising a flexible cage are described in the documents WO 2021/001610 and WO 2022/195198 in the name of the Applicant. The dampening of the response of the low-pressure shaft 11 owing to these bearing mode dampers 25 thus makes it possible to limit the resonance of the low-pressure shaft when its frequency reaches the first deformation mode.

The bearings 11a-11c of the low-pressure shaft 11 preferably comprise exactly three bearings, namely the front bearing 11a and the two rear bearings 11b, 11c.

Note that the formula (1) is applicable to any type of bearing. By way of example, the front bearing 11a may comprise a ball bearing, a tapered roller bearing or an angular contact ball bearing, and the rear bearings 11b, 11c may each comprise a roller bearing.

The low-pressure shaft 11 being housed in the high-pressure shaft 10, its diameter is restricted by the average radius R_{m_a} of the bore the high-pressure turbine 7. However, the greater the diameter of the low-pressure shaft 11, the more its own modes appear at high rotation speeds (or, in other words, the more the shaft deformation modes are shifted into the high frequencies). In order to obtain a trade-off between a mean bore radius of the high-pressure turbine 7 of small diameter—which makes it possible to improve the overall pressure ratio of the propulsion system and its bypass ratio BPR—while controlling the dynamic situation of the low-pressure shaft 11, the average radius R_{m_a} of a bore of the high-pressure turbine 7 obeys the following formula, in particular when the fan section 2 is ducted:

$${R}_{m \_ a} \leq E * {L}_{H P}^{2} * X N * 1 {0}^{- 9} + {F}_{1} \qquad ( 5 )$$

where: R_{m_a} is expressed in millimeters (mm);
   L_{HP} is the length of the high-pressure spool, in millimeters (mm);
   E=3.15 (mm·rpm)⁻¹ and F₁=23 millimeters (mm).

Specifically, and as we have seen above, the deformation frequency of the low-pressure shaft 11 is proportional to the ratio between the diameter of the low-pressure shaft 11 and the squared distance (d₁²) between the bearings 11a-11b of the low-pressure shaft 11. Thus, the further apart the bearings 11a-11b supporting the low-pressure shaft 11, the lower the deformation frequency (and therefore the deformation modes) of the low-pressure shaft 11. However, the position of the bearings 11a-11b of the low-pressure shaft 11 depends on the length of the high-pressure spool. By defining the average radius R_{m_a} of the bore of the high-pressure turbine 7 as a function of the length of the high-pressure spool L_{HP} (which is formed of the high-pressure compressor 5 and of the high-pressure turbine 7), the dynamic behavior of the low-pressure shaft 11 can therefore be better controlled.

Preferably, the average radius R_{m_a} of the bore of each disc of the high-pressure turbine 7 obeys the formula (5).

A propulsion system 1 for which the average radius R_{m_a} of the bore of the high-pressure turbine 7 obeys the formula (5) can then reach an overall pressure ratio, which corresponds to the pressure ratio between the pressure at the outlet of the high-pressure compressor 5 and the pressure at the inlet of the fan rotor 9 (measured at the root of the fan rotor 9), be greater than or equal to 40 and less than or equal to 70, preferably greater than or equal to 44 and less than or equal to 55.

The rotation speed of the high-pressure turbine 7 can then be between 15 000 revolutions per minute and 27 000 revolutions per minute. When the rotation speed of the high-pressure turbine (and therefore of the high-pressure shaft 10) is contained in this interval and its average radius R_{m_a} obeys the formula (4), the mechanical loading of the rotors 7a is acceptable for the high-pressure turbine 7.

The length of the high-pressure spool L_{HP} can for example be between 950 mm and 1450 mm for a high-pressure spool comprising between ten and thirteen compressor and turbine stages.

The average radius R_{m_a} of a bore of the high-pressure turbine 7 also obeys the following formula, in particular when the fan section 2 is ducted:

$${R}_{m \_ a} \geq E * {L}_{H P}^{2} * X N * 1 {0}^{- 9} + {F}_{2} \qquad ( 6 )$$

where: F₂=13 millimeters (mm).

The dimensioning of the average radius of the bore such as to obey the formula (6) ensures a minimum radius for the high-pressure turbine and therefore guarantees its ability to withstand centrifugal forces.

In some cases, the average radius of the bore R_{m_a} of the high-pressure turbine 7 is dimensioned before being able to determine the length of the high-pressure spool L_{HP}. In this case, the average radius of the bore can be determined based on the fundamental dimensioning parameters that are the diameter D₉ of the fan rotor 9, the bypass ratio BPR of the propulsion system 1 or again the redline speed XN of the low-pressure shaft 11, rather than the length of the low-pressure spool (as defined in the formulae (5) and (6):

$${R}_{m \_ a} \leq K * {( L * \sqrt{\frac{{D}_{9}^{2}}{B P R + 1} * {( {T}_{e} + {T}_{ref} )}^{0.5 - \frac{G A M M A}{G A M M A - 1}} * 1 {0}^{3}} * n + M )}^{2} * XN * 1 {0}^{- 9} + {N}_{1} \qquad ( 7 )$$

where: BPR is the bypass ratio of the propulsion system 1;
   Tₑ is the temperature at the inlet of the low-pressure turbine 8, in degrees Celsius;

$${T}_{ref} = 273 K ;$$

n is the number of stages in the high-pressure spool (i.e. in the high-pressure turbine 7 and in the high-pressure compressor 5);
GAMMA is the adiabatic coefficient of air;
K=6.76, L=153.6 m⁻¹·(° C.)^{-1/2}·(rpm)⁻¹, M=421 mm·(° C.)^{1/2} and N₁=−11 millimeters (mm).

As specified for formula (6), when the average radius of the bore R_{m_a} of the high-pressure turbine 7 obeys the formula (7), the dynamic behavior of the low-pressure shaft 11 can thus be better controlled.

Preferably, the average radius R_{m_a} of the bore of each disc of the high-pressure turbine 7 obeys the formula (7).

In addition, the average radius of the bore also obeys the following formula:

$${R}_{m \_ a} \geq K * {( L * \sqrt{\frac{{D}_{9}^{2}}{B P R + 1} * {( {T}_{e} + {T}_{r e f} )}^{0.5 - \frac{G A M M A}{G A M M A - 1}} * 1 {0}^{3}} * n + M )}^{2} ⋆ XN * 1 {0}^{- 9} + {N}_{2} \qquad ( 8 )$$

where N₂=−21 millimeters (mm).

Preferably, the average radius R_{m_a} of the bore of each disc of the high-pressure turbine 7 obeys the formula (8).

Preferably, the propulsion system 1 is also dimensioned such that the average radius R_{m_a} of the bore of the high-pressure turbine 7 moreover obeys the following formula, in particular when the fan section 2 is ducted:

$${R}_{m \_ a} \leq I * FN * BPR * 1 {0}^{- 4} + J \qquad ( 9 )$$

where: FN is the thrust of the fan rotor 9, in Newton (N); and
   I=0.16 millimeters per Newton (mm/N) and J=28 millimeters (mm).

Specifically, the torque transmitted by the low-pressure shaft 11 to the fan rotor 9 is related to the thrust of the fan rotor 9 and to the bypass ratio BPR of the propulsion system 1. Moreover, the increase of the bypass ratio BPR of the propulsion system 1 makes it possible to reduce the diameter of the high-pressure spool, and therefore of the average radius R_{m_a} of the bore of the high-pressure turbine 7. Thus, by dimensioning the propulsion system such that the average radius R_{m_a} of the bore of the high-pressure turbine 7 also obeys the formula (9), a propulsion system 1 is obtained in which the size of the high-pressure spool and the diameter of the low-pressure shaft 11 are dimensioned as a function of the thrust of the fan rotor 9 (which mainly contributes to the overall thrust of the propulsion system 1) and of the bypass ratio BPR.

Preferably, the average radius R_{m_a} of the bore of each disc of the high-pressure turbine 7 obeys the formula (9).

For example, the average radius of the bore of the high-pressure turbine is at the most equal to 300 mm.

In a form of embodiment, in order to maintain the possibility of inserting into and passing the low-pressure shaft 11 through the high-pressure shaft 10, while guaranteeing the capacity of the low-pressure shaft 11 to transmit the torque needed for the fan rotor 9 and the low-pressure compressor 4, the average radius R_{m_a} of the bore of the second turbine 7 moreover obeys the following formula, in particular when the fan section 2 is ducted:

$${R}_{m \_ a} \geq G * F N * B P R * 1 {0}^{- 4} + H \qquad ( 10 )$$

where: G=0.16 millimeters per Newton (mm/N) and H=18 millimeters (mm).

Preferably, the average radius R_{m_a} of the bore of each disc of the high-pressure turbine 7 obeys the formula (10).

### Comparative Example

The engine 1 is a twin-spool propulsion system comprising a ducted fan section 2 corresponding to the current technical standard (at the date of filing of this application) that it is desirable to improve.

The engine 2 is a twin-spool propulsion system 1 comprising a ducted fan section 2 in accordance with the teachings of this application, the drive shaft of which (i.e. here the low-pressure shaft) is supported by bearings that obey the formulae (1) and (2) defined above.

The engine 1 and the engine 2 both have a low-pressure shaft supported by exactly one bearing upstream of the combustion chamber and two bearings downstream of the combustion chamber. In addition, the front bearing comprises damping by pressurized fluid film.

| | | | Engine 2 | |
|---|---|---|---|---|
| | | | (in accordance with the | |
| Dimensioning parameter (SLS unless | Engine 1 | | disclosure of this | |
| otherwise specified) | (reference engine) | | application) | |
| Average radius of the low-pressure turbine Rm | 366.3 | mm | 310.9 | mm |
| Bearing-to-bearing distance d₂ | 234.9 | mm | 299.4 | mm |
| Redline speed of the low-pressure shaft (XN) | 9 541 | rpm | 10 025 | rpm |
| (redline) | | | | |
| Average radius of the rear bearing R_{11b} | 62.6 | mm | 61.2 | mm |
| $\frac{{R}_{m}}{{d}_{2}}$ | 1.56 | | 1.04 | |
| $C * X N * \frac{{d}_{1}^{2}}{{R}_{11 b}} * 1 {0}^{- 11} + {E}_{2}$ | 1.22 | | 1.53 | |
| $C * X N * \frac{{d}_{1}^{2}}{{R}_{11 b}} * 1 {0}^{- 11} - {E}_{1}$ | 0.66 | | 0.97 | |
| Bearing-to-bearing distance d₁ | 1 804.1 | mm | 2 034.9 | mm |
| $A * \frac{{R}_{11 b}}{{d}_{1}^{2}} * 1 {0}^{5}$ | 10 572 | rpm | 8 126 | rpm |
| $B * \frac{{R}_{11 b}}{{d}_{1}^{2}} * 1 {0}^{5}$ | 16 340 | rpm | 12 559 | rpm |
| Diameter of the low-pressure shaft, measured | 87.2 | mm | 81.5 | mm |
| plumb with the high-pressure turbine disc | | | | |
| Average radius of the bore of the high- | 53.8 | mm | 51.5 | mm |
| pressure turbine Rₘ_a | | | | |
| Length of high-pressure spool L_{HP} | | | | |
| E * L_{HP}² * XN * 10⁻⁹ + F₁ | 54.1 | mm | 61.3 | mm |
| E * L_{HP}² * XN * 10⁻⁹ + F₂ | 44.1 | mm | 51.3 | mm |
| Diameter of the fan rotor D₉ | 2.0574 | m | 2.2352 | m |
| Bypass ratio BPR | 12.0 | | 13.0 | |
| Temperature at the inlet of the low-pressure | 1026° C. | | 1066° C. | |
| turbine (redline) | | | | |
| Number of high-pressure compressor stages | 9 | | 10 | |
| Number of high-pressure turbine stages | 2 | | 2 | |
| $K * {( L * \sqrt{\frac{{D}_{9}^{2}}{B P R + 1} * {( {T}_{e} + {T}_{r e f} )}^{0.5 - \frac{G A M M A}{G A M M A - 1}} * 1 {0}^{3}} * n + M )}^{2} * XN * {10}^{- 9} + {N}_{1}$ | 82.5 | mm | 91.4 | mm |
| $K * {( L * \sqrt{\frac{{D}_{9}^{2}}{B P R + 1} * {( {T}_{e} + {T}_{r e f} )}^{0.5 - \frac{G A M M A}{G A M M A - 1}} * 1 {0}^{3}} * n + M )}^{2} * XN * {10}^{- 9} + {N}_{2}$ | 50.5 | mm | 59.4 | mm |

| | | | | |
|---|---|---|---|---|
| Thrust of the fan FN | 152 0382 | N | 151 630 | N |
| G * FN * BPR * 10⁻⁴ + H | 48.9 | mm | 57.9 | mm |
| I * FN * BPR * 10⁻⁴ + J | 58.9 | mm | 67.9 | mm |

| Number of fan blades | 18 | | 18 | |
|---|---|---|---|---|
| Pressure ratio of the fan | 1.44 | | 1.40 | |
| Reduction ratio | 2.88 | | 3.30 | |
| Hub-to-tip ratio of the fan rotor | 0.30 | | 0.30 | |
| Redline speed of the fan rotor (redline) | 3 316 | rpm | 3 039 | rpm |
| Redline speed of the high-pressure shaft 10 | 21 178 | rpm | 22 252 | rpm |
| (redline) | | | | |

| | | |
|---|---|---|
| Pressure ratio of the low-pressure compressor | 1.85 | 2.51 |
| Overall pressure ratio | 42 | 55 |
| Number of low-pressure compressor stages | 2 | 3 |
| Number of low-pressure turbine stages | 3 | 4 |
| Temperature at the inlet of the high-pressure | 1850° C. | 1930° C. |
| turbine | | |
| N₇²S₇ | 36.4 × 10⁶ | 40.2 × 10⁶ (rpm)²·m² |
| (where S₇ is the outlet section of the low- | (rpm)²·m2 | |
| pressure turbine) | | |
| XN²S₈ | 36.4 × 106 | 40.2 × 10⁶ (rpm)²·m² |
| (where S₈ is the outlet section of the low- | (rpm)²·m² | |
| pressure turbine) | | |

The ratio of the average radius of the low-pressure turbine to the bearing-to-bearing distance d₂ is greater than the maximum value defined by the formula (2) as a function of the redline speed of the low-pressure shaft, of the bearing-to-bearing distance d₁ and of the radius of the upstream rear bearing R_{11b} of the low-pressure shaft. The consequence is that the first deformation mode of the low-pressure shaft, which is supercritical, takes place at a transient rating near takeoff rating. Hence the vibrational loads experienced during the change of mode are high despite the presence of the bearing mode damper. This is also apparent from the fact that the redline speed of the low-pressure shaft of the engine 1 is less than the minimum redline speed defined by the formula (3) as a function of the radius of the upstream rear bearing R_{11b} of the low-pressure shaft and of the bearing-to-bearing distance d₁.

By comparison, the ratio of the average radius of the low-pressure turbine to the bearing-to-bearing distance of the engine 2 obeys the formulae d₂ (1) and (2). The stiffness of the low-pressure shaft is therefore increased such that the first mode of deformation of the low-pressure shaft, which is supercritical, occurs in a transient operating range closer to idle. The bearing mode damper also makes it possible to dampen the mode change, bearing in mind that the vibrational loads are moderate in the engine 2 in this operating range by comparison with the vibrational loads undergone by the engine 1. In addition, since the low-pressure shaft is more rigidly fixed, its diameter can be limited, despite the fact that it drives seven stages in all (three compressor stages 4 and four turbine stages 8). The bearings that support the low-pressure shaft do however remain near enough to allow their integration underneath the low-pressure turbine. Finally, the average radius of the low-pressure turbine 8 of the engine 2 is smaller than that of the engine 1, despite a larger number of stages, such that the low-pressure turbine 8 of the engine 2 is radially more compact than the low-pressure turbine of the engine 1.

Furthermore, the redline speed of the low-pressure shaft of the engine 2 is greater than the minimum redline speed defined by the formula (3), such that the second deformation mode of the low-pressure shaft is located outside the operating range of the engine 2. The redline speed of the low-pressure shaft of the engine 2 does however remain less than the maximum redline speed defined in the formula (4) to limit the vibrational loads experienced during the mode change. The mechanical stresses in the low-pressure shaft and in the low-pressure turbine therefore remain acceptable, as can be seen, in particular, from the mechanical loading parameter of the low-pressure turbine XN²S₈.

To change from the engine 1 (reference) to the engine 2 (in accordance with the disclosure), the diameter D₉ of the fan and the bypass ratio BPR have been increased, which has made it possible to improve the propulsive efficiency and to conserve a comparable fan thrust given the drop in the pressure ratio of the fan section 2. Moreover, the overall pressure ratio has been increased, as well as the temperature at the inlet of the high-pressure turbine 7, which has made it possible to increase the thermal efficiency of the propulsion system 1.

Moreover, the outer diameter of the shaft of the low-pressure turbine 11 has been reduced to simplify the integration of the high-pressure spool in particular by complying with the mechanical dimensioning of the discs of the high-pressure turbine.

The adjustment to obtain a redline speed of the first deformation mode of the low-pressure shaft 11 in the rating range defined by the formulae (1) to (4) has been done by adapting the distance d₂ between the centers of gravity of the rear bearings of the low-pressure shaft 11 and by optimizing the internal geometry of the low-pressure shaft 11 while complying with the manufacturing stresses of the shaft 11.

The number of bearings supporting the low-pressure shaft has been kept equal to 3 (and has not been increased to 4) for reasons of integration of the bearing upstream of the low-pressure shaft, given the position of the air path of the low-pressure compressor.

The solution of moving one of the two bearings forward, or moving the two bearings downstream of the low-pressure turbine upstream thereof, has also been dismissed to avoid an elongation of the engine 2 and a problem of misalignment between the two bearings.

1. An aeronautical propulsion system comprising:
a fan rotor configured to be driven by a fan shaft;
a drive turbine configured to drive the fan rotor through a drive shaft about an axis of rotation;
a reduction mechanism coupling the drive shaft and the fan shaft to drive the fan shaft at a rotation speed less than a rotation speed of the drive shaft;
bearings configured to center the drive shaft with respect to the axis of rotation, the bearings comprising one front bearing extending upstream of a combustion chamber of the propulsion system and two rear bearings extending downstream of the combustion chamber,
wherein a position of the bearings in the propulsion system obeys the following formula:
$$C * X N * \frac{{d}_{1}^{2}}{{R}_{11 b}} * 1 {0}^{- 11} + {E}_{2} \geq \frac{{R}_{m}}{{d}_{2}} \geq C * X N * \frac{{d}_{1}^{2}}{{R}_{11 b}} * 1 {0}^{- 11} - {E}_{1}$$
where: d₂ is a distance between centers of gravity of the rear bearings of the drive shaft, in millimeters;
Rₘ is an average radius of the drive turbine, in millimeters;
XN is a redline speed of the drive shaft, in revolutions per minute;
d₁ is a distance between a center of gravity of the front bearing and a center of gravity of the rear bearing nearest to the front bearing, in millimeters;
R_{11b} is an average radius of the rear bearing nearest to the front bearing, in millimeters; and
C=170 (mm*rpm)⁻¹, E₁=0.18 and E₂=0.378.

2. The propulsion system as claimed in claim 1, wherein the redline speed of the drive shaft obeys the following formula:
$$X N \geq A * \frac{{R}_{11 b}}{{d}_{1}^{2}} * 1 {0}^{5}$$
where A=5 500 mm*rpm.

3. The propulsion system as claimed in claim 1, wherein the redline speed of the drive shaft obeys the following formula:
$$X N \leq B * \frac{{R}_{11 b}}{{d}_{1}^{2}} * 1 {0}^{5}$$
where B=8 500 mm*rpm.

4. The propulsion system as claimed in claim 1, wherein all or part of the bearings of the drive shaft are associated with a bearing mode damper.

5. The propulsion system as claimed in claim 4, wherein the bearing mode dampers comprise a squeeze film.

6. The propulsion system as claimed in claim 1, wherein each bearing mode damper comprises a deformable cage mounted between a ring of the associated bearing and a stator part of the propulsion system.

7. The propulsion system as claimed in claim 1, wherein the bearings of the drive shaft comprise at least one front bearing and exactly two rear bearings.

8. The propulsion system as claimed in claim 1, further comprising an additional turbine configured to drive an additional compressor by way of an additional shaft, the additional shaft being configured to rotate at a higher speed than the drive shaft about the axis of rotation, the additional turbine being two-stage.

9. The propulsion system as claimed in claim 8, wherein the additional compressor comprises at least eight stages and at the most eleven stages.

10. The propulsion system as claimed in claim 1, wherein the drive turbine comprises at least three stages and at the most five stages.

11. The propulsion system as claimed in claim 1, wherein a reduction ratio of the reduction mechanism is greater than or equal to 2.5 and less than or equal to 11.

12. An aircraft comprising at least one of the propulsion system as claimed in claim 1,
wherein the at least one of the propulsion system is attached to the aircraft by a pylon.

13. A method for dimensioning a propulsion system comprising a reduction mechanism coupling a drive shaft and a fan rotor to drive the fan rotor at a speed less than a speed of the drive shaft, and bearings configured to center the drive shaft with respect to an axis of rotation, the bearings comprising one front bearing extending upstream of a combustion chamber of the propulsion system and two rear bearings extending downstream of the combustion chamber,
the method comprising dimensioning the propulsion system such that a position of the bearings in the propulsion system obeys the following formula:
$$C * X N * \frac{{d}_{1}^{2}}{{R}_{11 b}} * 1 {0}^{- 11} + {E}_{2} \geq \frac{{R}_{m}}{{d}_{2}} \geq C * X N * \frac{{d}_{1}^{2}}{{R}_{11 b}} * 1 {0}^{- 11} - {E}_{1}$$
where: d₂ is a distance between centers of gravity of the rear bearings of the drive shaft, in millimeters;
Rₘ is an average radius of the drive turbine, in millimeters;
XN is a redline speed of the drive shaft, in revolutions per minute;
d₁ is a distance between a center of gravity of the front bearing and a center of gravity of the rear bearing nearest to the front bearing, in millimeters;
R_{11b} is an average radius of the rear bearing nearest to the front bearing, in millimeters; and
C=170 (mm*rpm)⁻¹, E₁=−0.18 and E₂=0.378.

14. The method as claimed in claim 13, wherein the dimensioning comprises dimensioning the propulsion system also such that the redline speed of the drive shaft obeys the following formula:
$$X N \geq A * \frac{{R}_{11 b}}{{d}_{1}^{2}} * 1 {0}^{5}$$
where A=5 500 mm*rpm.

15. The method as claimed in claim 13, wherein the dimensioning comprises also dimensioning the propulsion system such that the redline speed of the drive shaft moreover obeys the following formula:
$$X N \leq B * \frac{{R}_{11 b}}{{d}_{1}^{2}} * 1 {0}^{5}$$
where B=8 500 mm*rpm.

16. A method for manufacturing an aeronautical propulsion system, the method comprising:
dimensioning the aeronautical propulsion system in accordance with the method as claimed in claim 13; and
manufacturing the aeronautical propulsion system.
